(19) United States
(12) Patent Application Publication
(10) Pub. No.: US 2010/0135661 A1
(43) Pub. Date: Jun. 3, 2010

(54) ETHERNET-BASED NEXT GENERATION OPTICAL TRANSPORT NETWORK APPARATUS AND TRAFFIC GROOMING METHOD THEREOF

(75) Inventors: Ji Wook YOUN, Daejeon (KR); Hong Ju KIM, Daejeon (KR); Byung Jun AHN, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/582,416

(22) Filed: Oct. 20, 2009

(30) Foreign Application Priority Data
Dec. 1, 2008 (KR) 10-2008-0120783
Apr. 24, 2009 (KR) 10-2009-0036031

(51) Int. Cl. H04J 14/00

(52) U.S. Cl. 398/68

(57) ABSTRACT

An Ethernet-based next generation optical transport network apparatus and a traffic grooming method in the apparatus are disclosed to provide a traffic grooming function to simultaneously transmit Ethernet data and a TDM signal through the same wavelength and provide a differentiated protection switching function by the flows to effectively support an Ethernet service in an optical transport network.

### CROSS-REFERENCE TO RELATED APPLICATIONS

This application claims the priorities of Korean Patent Application No. 10-2008-0120783 filed on Dec. 1, 2008, and Korean Patent Application No. 10-2009-0036031 filed on Apr. 24, 2009, in the Korean Intellectual Property Office, the disclosures of which are incorporated herein by reference.

### BACKGROUND OF THE INVENTION

1. Field of the Invention

The present invention relates to an Ethernet-based next generation optical transport network apparatus and a traffic grooming method thereof, and more particularly, to an Ethernet-based next generation optical transport network apparatus for providing a traffic grooming function to simultaneously transmit Ethernet data and a TDM (Time Division Multiplexing) signal through the same wavelength and provide a differentiated protection switching function by the flows to effectively support an Ethernet service in an optical transport network and, and a traffic grooming method.

2. Description of the Related Art

In general, an optical transport network has a wide bandwidth, a high level of reliability, a well-developed protection switching function, and an CAM technique. Accordingly, research on Ethernet-based optical transport networks is actively ongoing to support Ethernet services which are of explosive growth currently.

FIG. 1 illustrates the configuration for accepting Ethernet data in an optical transport network according to the related art. In the related art Ethernet transport technique via the optical transport network, Ethernet data is included in a SONET/SDH signal or an OTH signal having a higher transmission rate than that of Ethernet data.

However, the related art Ethernet transport network technique has shortcomings in that it cannot effectively switch the Ethernet data. In other words, in the related art Ethernet transport network in which Ethernet data is simply multiplexed into a signal with a high transmission rate, which is then transmitted via the optical transport network, every node requiring switching needs to perform electro-optic and photoelectric conversions to switch the Ethernet data.

Thus, the related art Ethernet transport technique using the optical transport network is disadvantageous in that the Ethernet data switching incurs a high system cost and it is impossible to switch Ethernet data cost-effectively.

### SUMMARY OF THE INVENTION

An aspect of the present invention provides an Ethernet-based next generation optical transport network apparatus for providing a traffic grooming function to simultaneously transmit Ethernet data and a TDM signal through the same wavelength and provide a differentiated protection switching function by the flows to effectively support an Ethernet service in an optical transport network and, and a traffic grooming method.

According to an aspect of the present invention, there is provided an Ethernet-based next generation optical transport network apparatus including: a subscriber network interface configured to provide an interface with a subscriber network; one or more optical signal distributors configured to branch a wavelength division multiplexed (WDM) optical signal input from an adjacent node; one or more optical demultiplexers configured to demultiplex the WDM optical signals which have been input from the optical signal distributors, by wavelengths; a traffic grooming module configured to classify Ethernet frames and TDM (Time Division Multiplexing) frames, which have been input from the subscriber network interface, by the flows and allocate virtual optical channels, and separate virtual optical channels from an optical wavelength which has been input from the optical demultiplexer and allocate new virtual optical channels; an optical wavelength conversion module configured to allocate a new optical wavelength to a signal input from the traffic grooming module; one or more optical multiplexers configured to perform wavelength division multiplexing (WDM) on a plurality of optical wavelength signals input from the traffic grooming module; an optical wavelength switching module configured to switch optical wavelengths input from the optical signal distributor and the optical multiplexer; and a control module configured to generate a control signal for controlling the traffic grooming module, the optical wavelength conversion module, and the optical wavelength switching module based on resources available in a network, and provide the generated control signal.

If the optical wavelength input from the optical demultiplexer needs wavelength conversion, the traffic grooming module may transfer the optical wavelength to the optical wavelength conversion module, while if the optical wavelength is used in a local network, the traffic grooming module may transfer the optical wavelength to the subscriber network interface.

The traffic grooming module may include: an L2/L3+ information processing unit configured to process L2/L3 or higher information of the Ethernet frame which has been input via the subscriber network interface; a TDM information processing unit configured to process header information of a TDM frame which has been input via the subscriber network interface; a flow generation unit configured to generate a flow from the Ethernet frame which has been input from the L2/L3+ information processing unit and the TDM frame which has been input from the TDM information processing unit; a switching unit configured to switch the flow which has been generated by the flow generating unit; a virtual optical channel generation/termination unit configured to allocate a virtual optical channel to the flow which has been input from the switching unit; and an optical wavelength allocation unit configured to allocate a pertinent wavelength to the virtual optical channel which has been input from the virtual optical channel generation/termination unit and map it to one or more optical wavelengths.

The virtual optical channel generation/termination unit may separate the virtual optical channel from the optical wavelength which has been input via the optical demultiplexer and interpret and process virtual optical channel information.

The virtual optical channel generation/termination unit may discriminate a virtual optical channel which needs traffic grooming or a virtual optical channel which needs local branching by interpreting the virtual optical channel information, allocate a new flow to the virtual optical channel which needs traffic grooming, and groom it together with the frame which has been input via the subscriber network interface.

The L2/L3+ information processing unit may interpret L2/L3 or higher input Ethernet frame header information, acquire input Ethernet frame priority information upon interpreting class of service (CoS) information, interpret an Ethernet frame service type classified according to a service level agreement (SLA), and discard the Ethernet frame if it is not consistent with the SLA.

The flow generation unit may generate flows in consideration of priority levels of respective frames by destinations and services of by using one or more of physical optical interface subscriber information, L2 header information, VLAN tag information, a service type, L3 header information, and TDM frame header information.

The traffic grooming module may allocate a virtual optical channel to the flows which have been generated in consideration of the priority levels of the input Ethernet frames by destinations and service.

If a virtual optical channel, which has been allocated to a flow with a higher priority level among the generated flows, has an error, the traffic grooming module may reallocate a virtual optical channel, which has been allocated to a flow with a lower priority level, to the flow with the higher priority level.

According to another aspect of the present invention, there is provided a traffic grooming method including: processing L2/L3 or higher information of an input Ethernet frame; processing header information of input TDM frame; generating a flow from the Ethernet frame and the TDM frame; switching the generated flow; allocating a virtual optical channel based on the generated flow; and mapping the virtual optical channel to an optical wavelength.

The L2/L3 or higher information processing may include: interpreting L2 header information of the input Ethernet frame; if the input Ethernet frame is a tagged frame, acquiring priority information of the Ethernet frame by interpreting class of service (CoS) information; classifying the input Ethernet frame according to a service level agreement (SLA); and interpreting service type and L3 header information of the Ethernet frame which has been classified according to the SLA.

The L2/L3 or higher information processing may further include: if the input Ethernet frame is not consistent with the SLA, discarding the input Ethernet frame.

In generating flows, the flows may be generated in consideration of priority levels of respective frames by destinations and services by using one or more of physical optical interface information of a subscriber, L2 header information, VLAN tag information, a service type, L3 header information, and header information of a TDM frame.

The traffic grooming method may further include: determining whether or not a received optical wavelength needs to be converted; if the received optical wavelength needs to be converted, converting the wavelength; and switching the optical wavelength and outputting the same.

The traffic grooming method may further include: if the received optical wavelength does not need to be converted, determining whether or not the received optical wavelength is to be locally branched; if the received optical wavelength is a signal used in a local network, separating a virtual optical channel from the optical wavelength and interpreting virtual optical channel information; determining whether or not the separated virtual optical channel needs traffic grooming; and if the separated virtual optical channel needs traffic grooming, generating a new flow including the separated virtual optical channel in the step of generating of the flow.

The traffic grooming method may further include: if the separated virtual optical channel does not need traffic grooming, branching the virtual optical channel into a local node.

The traffic grooming method may further include: if the received optical wavelength does not need to be converted, determining whether or not the received optical wavelength is to be locally branched; if the received optical wavelength is a signal which is not used in the local network, separating a virtual optical channel from the optical wavelength and interpreting virtual optical channel information; determining whether or not the separated virtual optical channel needs traffic grooming; and if the separated virtual optical channel needs traffic grooming, generating a new flow including the separated virtual optical channel in the step of generating of the flow.

The traffic grooming method may further include: if the separated virtual optical channel does not need traffic grooming, discarding the virtual optical channel.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates the structure for accepting Ethernet data in the related art optical transport network;

FIG. 2 illustrates the structure of an Ethernet-based next generation optical transport network according to an exemplary embodiment of the present invention;

FIG. 3 is a detailed view showing the configuration of a traffic grooming module included in a next-generation optical transport network apparatus according to an exemplary embodiment of the present invention;

FIG. 4 illustrates a bandwidth allocation in the next-generation optical transport network apparatus according to an exemplary embodiment of the present invention;

FIG. 5 illustrates generation of virtual optical channels and allocation of optical wavelengths in the next-generation optical transport network apparatus according to an exemplary embodiment of the present invention;

FIG. 6 illustrates traffic transmission between VPNs via an Ethernet-based next-generation optical transport network according to an exemplary embodiment of the present invention;

FIG. 7 illustrates a traffic grooming function in the next-generation optical transport network apparatus 1 in FIG. 6;

FIG. 8 illustrates a traffic grooming function in the next-generation optical transport network apparatus 2 in FIG. 6;

FIGS. 9a to 9c illustrate protection switching through virtual optical channels in the Ethernet-based next-generation optical transport network according to an exemplary embodiment of the present invention; and

FIG. 10 is a flow chart illustrating the process of transmitting an Ethernet frame and a TDM frame via the Ethernet-based next generation optical transport network according to an exemplary embodiment of the present invention.

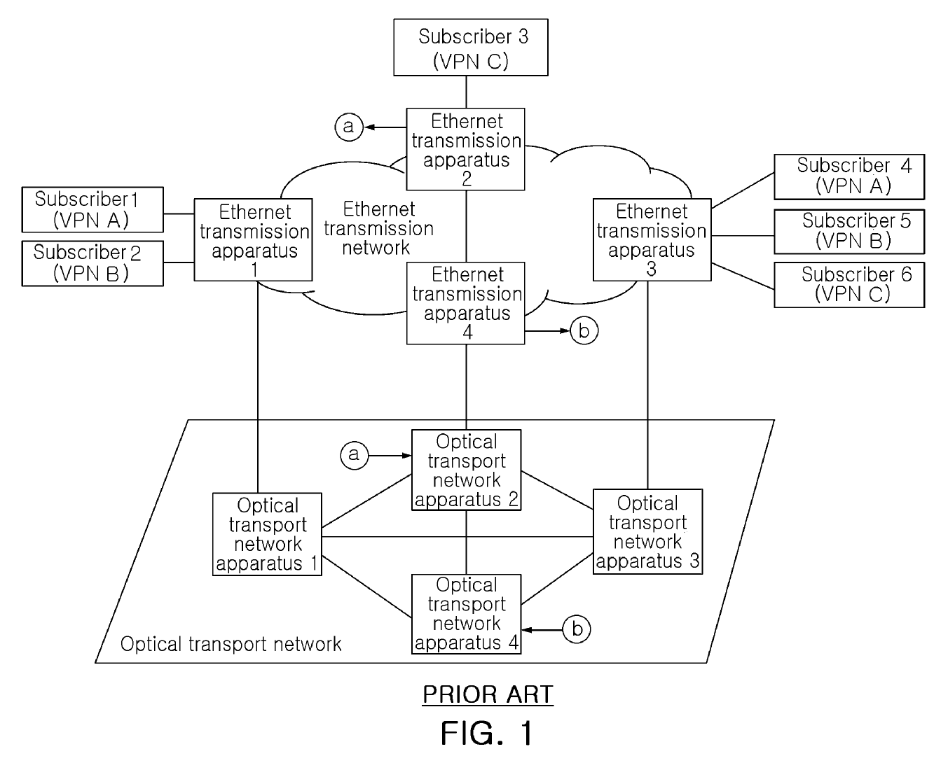

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

Also, the term “module” or “part” refers to a single unit performing a particular function or operation, which can be implemented by hardware or software, or a combination of hardware and software.

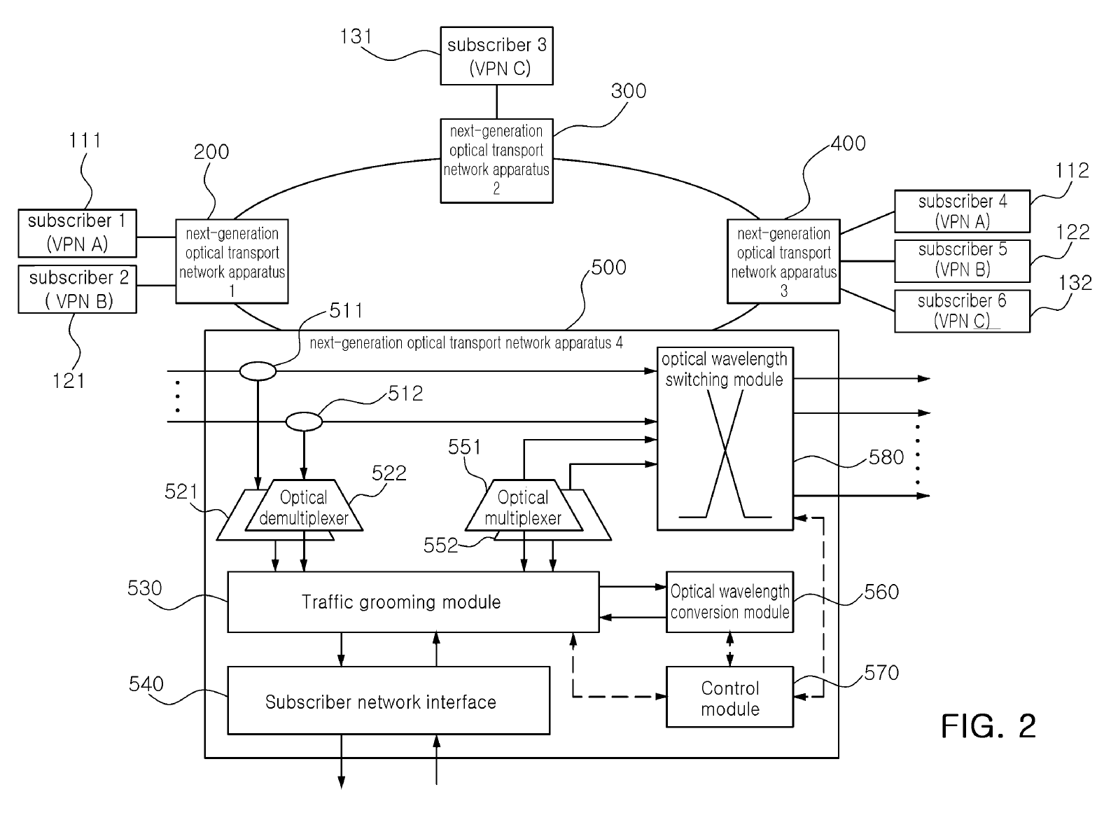

FIG. 2 illustrates the structure of an Ethernet-based next generation optical transport network according to an exemplary embodiment of the present invention.

As shown in FIG. 2, a plurality of subscribers 111, 112, 121, 122, 131, and 132 constitute mutually different virtual private networks (VPNs). For example, the subscribers 1(111) and 4(112) constitute a VPN A, the subscribers 2(121) and 5(122) constitute a VPN B, and the subscribers 3(131) and 6(132) constitute a VPN C.

Meanwhile, the VPNs including the plurality of subscribers are connected via next-generation optical transport network apparatus 200, 300, 400, and 500. Here, the next-generation optical transport network apparatus 200, 300, 400, and 500 classify Ethernet frames input from subscriber networks by the flows, allocate virtual optical channels through their traffic grooming function, and transmit traffic through an optical wavelength.

In more detail, the next-generation optical transport network apparatus 4(500) includes one or more optical signal distributors 511 and 522, one or more optical demultiplexers 521 and 522, a traffic grooming module 530, a subscriber network interface 540, one or more optical multiplexers 551 and 552, an optical wavelength conversion module 560, a control module 570, and an optical wavelength switching module 580.

The optical signal distributors 511 and 512 are positioned at input terminals of adjacent nodes and branch wavelength-division-multiplexed (WDM) optical signals input from the adjacent nodes into the optical wavelength switching module 580 and the optical demultiplexers 521 and 522. The optical signal distributors 511 and 512 are provided as many as the number of the adjacent nodes.

The optical demultiplexers 521 and 522 demultiplex the WDM optical signals, which have been input from the optical signal distributors 511 and 512, by the wavelengths and transfer the demultiplexed signals to the traffic grooming module 530. The optical demultiplexers 521 and 522 are also provided as many as the number of the adjacent nodes.

The traffic grooming module 530 separates virtual optical channels from the optical wavelengths input from the plurality of optical demultiplexers 521 and 522 according to a control signal from the control module 570.

Thereafter, if the separated virtual optical channels are local node signals which do not need traffic grooming, the traffic grooming module 530 output the same to a subscriber network via the subscriber network interface 540. If, however, the separated virtual optical channels are signals which need traffic grooming, the traffic grooming module 530 allocates new virtual optical channels, groom them with different virtual optical channels, and outputs the same to a corresponding adjacent node via the optical multiplexers 521 and 522.

If the optical signals, which have been input from the plurality of optical demultiplexers 521 and 522, need wavelength conversion, the traffic grooming module 530 transfers the optical signals to the optical signal conversion module 560. Accordingly, the optical signals may be converted into corresponding optical wavelengths by the optical wavelength conversion module 560 and then output to a corresponding adjacent node via the traffic grooming module 530 and the optical multiplexers 551 and 552.

In addition, the traffic grooming module 530 classifies Ethernet frames and TDM frames input from the subscriber network interface 540 by flows, allocates virtual optical channels to them, map them to corresponding optical wavelengths, and outputs the same via the optical multiplexers 551 and 552. In this case, the traffic grooming module 530 generates flows in consideration of priority levels of the input Ethernet frames according to destinations and services, and allocates virtual optical channels to the flows.

If an error occurs in a virtual optical channel allocated to a flow having a higher priority level, the traffic grooming module 530 reallocates a virtual optical channel, which has been allocated to a flow having a lower priority level, to the flow having the higher priority level, thereby providing a protection switching function differentiated by the flows.

The traffic grooming module 530 includes a plurality of hardware components providing such functions as described above, and the number of hardware components is equal to the number of optical wavelengths input to the traffic grooming module 530.

The subscriber network interface 540 provides an interface with the subscriber network to thus provide interwork ability between the subscriber network and the next-generation optical transport network apparatus 4 (500). The subscriber network and the next-generation optical transport network apparatus 4(500) interwork according to various protocols such as Ethernet, SONET/SDH, fiber channel (FC), and the like, via the subscriber network interface 540. Namely, the subscriber network interface 540 provides such various protocol connection functions. The optical multiplexers 551 and 552 perform WDM on the plurality of optical signals input from the traffic grooming module 530.

The optical wavelength conversion module 560 allocates a new optical wavelength to a signal input from the traffic grooming module 530 according to a control signal from the control module 570.

The control module 570 generates a control signal for controlling the generation of the bandwidths of the virtual optical channels allocated by the traffic grooming module 530, a control signal for generating the optical wavelengths allocated by the optical wavelength conversion module 560, and a control signal for controlling the switching performed by the optical wavelength switching module 580 based on resources available in the network, and provide each control signal to the traffic grooming module 530, the optical wavelength conversion module 560, and the optical wavelength switching module 580.

The optical wavelength switching module 580 switches optical wavelengths input from the optical signal distributors 511 and 512 and the optical multiplexers 551 and 552 to pertinent adjacent nodes according to a control signal from the control module 570.

The configuration of the next-generation optical transport network apparatus 4(500) has been described in detail, and the next-generation optical transport network apparatus 1 to 3 (200 to 400) also have the same configuration as that of the next-generation optical transport network apparatus 4(500).

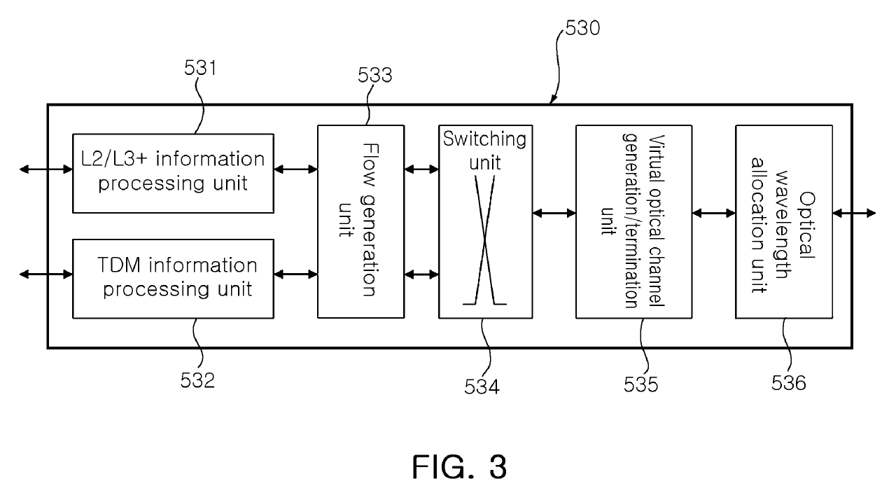

FIG. 3 is a detailed view showing the configuration of the traffic grooming module included in the next-generation optical transport network apparatus according to an exemplary embodiment of the present invention.

As shown in FIG. 3, the traffic grooming module 530 includes an L2/L3+ information processing unit 531, a TDM information processing unit 532, a flow generation unit 533, a switching unit 534, a virtual optical channel generation/termination unit 535, and an optical wavelength allocation unit 536.

The L2/L3+ information processing unit 531 processes L2 and L3 information of an Ethernet frame input from the subscriber network interface and transfers the same to the flow generation unit 533, and if necessary, the L2/L3+ information processing unit 530 can process information higher than L3. In detail, the L2/L3+ information processing unit 531 interprets L2 and L3 headers of the input Ethernet frame and, if necessary, header information higher than L3, interprets class of service (CoS) information to acquire an priority information of the Ethernet frame, and interprets the Ethernet frame service type classified according to a service level agreement (SLA). If the Ethernet frame is inconsistent with the SLA, the L2/L3+ information processing unit 531 discards the Ethernet frame.

The TDM information processing unit 532 processes TDM frame header information input from the subscriber network interface, and transfers the same to the flow generation unit 533. In detail, the TDM information processing unit 532 interprets the TDM frame header information to acquire destination information and priority information.

The flow generation unit 533 generates flows from the Ethernet frame which has been transferred from the L2/L3+ information processing unit 531 and the TDM frame which has been transferred from the TDM information processing unit 532. In this case, preferably, the flow generation unit 533 generates the flows in consideration of priority levels of respective frames by destinations and services by using one or more of physical optical interface information of a subscriber, L2 header information, VLAN tag information, a service type, L3 header information, and header information of a TDM frame.

The switching unit 534 switches the flows which have been generated by the flow generation unit 533.

The virtual optical channel generation/termination unit 535 allocates the respective flows, which have been input from the switching unit 534, to pertinent virtual optical channels. In detail, the virtual optical channel generation/termination unit 535 separates virtual optical channels from the optical wavelengths input via the optical demultiplexers 521 and 522, and interprets and processes information of the virtual optical channels. Upon interpreting the information from the virtual optical channels, the virtual optical channel generation/termination unit 535 discriminates a virtual optical channel that needs traffic grooming and a virtual optical channel that needs local branching, allocates a new flow to the virtual optical channel that needs traffic grooming, and grooms it together with a frame input via the subscriber network interface.

The optical wavelength allocation unit 536 maps one or more virtual optical channels, which have been generated by the virtual optical channel generation/termination unit 535, to one or more optical wavelengths.

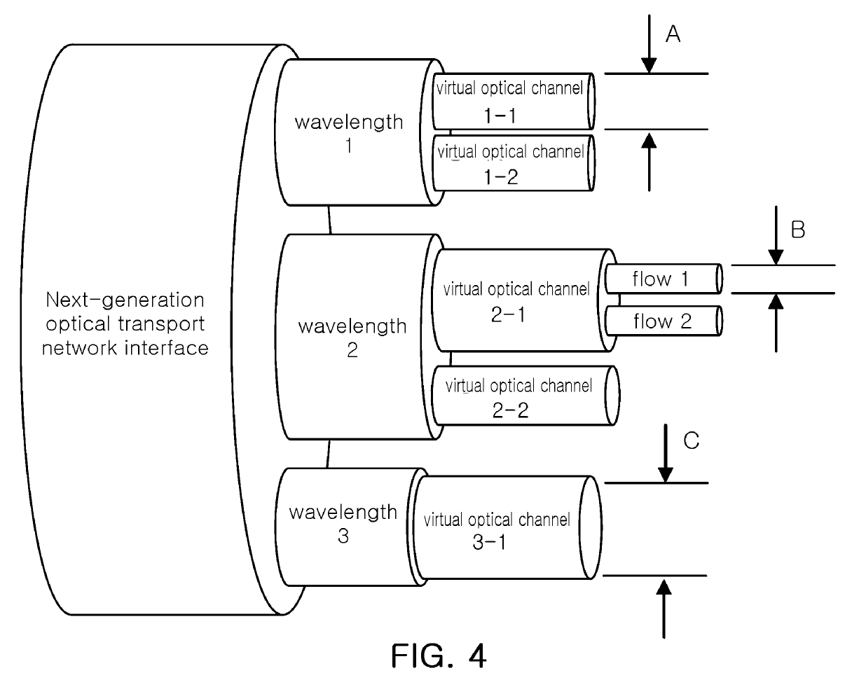

FIG. 4 illustrates a bandwidth allocation in the next-generation optical transport network apparatus according to an exemplary embodiment of the present invention. In an exemplary embodiment of the present invention, a bandwidth is allocated basically based on virtual optical channels (A), and may be allocated based on flows (B) or ports (C) according to circumstances.

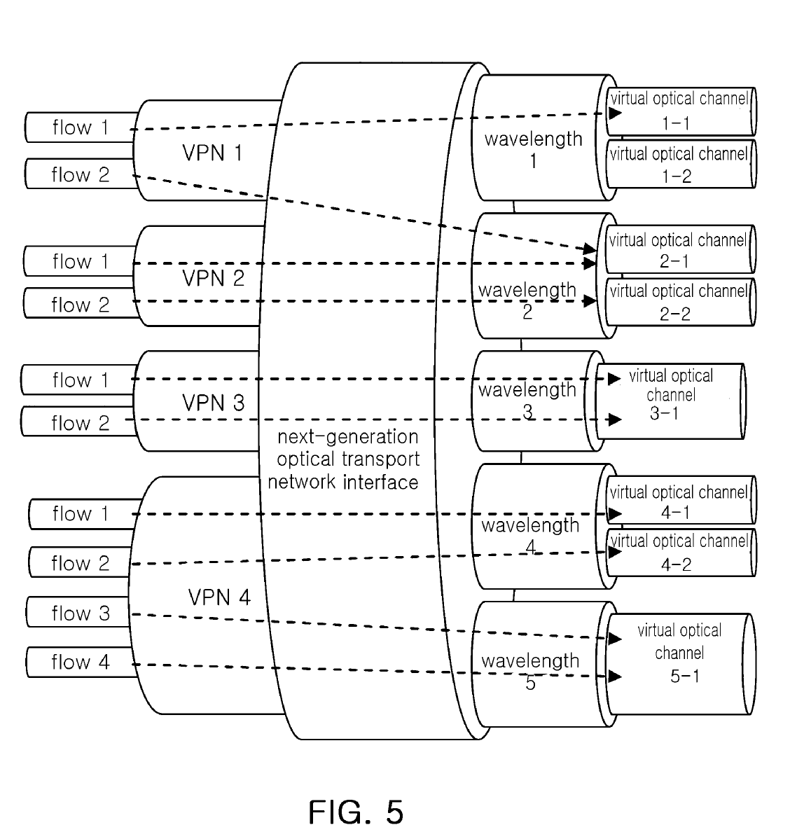

FIG. 5 illustrates generation of virtual optical channels and allocation of optical wavelengths in the next-generation optical transport network apparatus according to an exemplary embodiment of the present invention, in which flows may be input in various forms like VPNs 1 to 4 to various virtual optical channels.

In detail, in the case of the VPN 1, flows 1 and 2 are input to virtual optical channels 1-1 and 2-1 each positioned at a different optical wavelength.

In the case of the VPN 2, flows 1 and 2 are input to the virtual optical channels 2-1 and 2-2 positioned at a single optical wavelength.

In the case of the VPN 3, flows 1 and 2 are input to a single virtual optical channel 3-1 positioned at a single optical wavelength. In this case, the virtual optical channel 3-1 is a port-based virtual optical channel. Only the single virtual optical channel 3-1 exists in the wavelength 3, and traffic input from the VPN 3 is input to the wavelength 3 regardless of flow.

In the case of the VPN 4, the bandwidth of traffic input from the single VPN is larger than the bandwidth of an optical wavelength provided by the next-generation optical transport network. In this case, the traffic input from the VPN 4 may be transmitted through two wavelengths, namely, through the wavelengths 4 and 5.

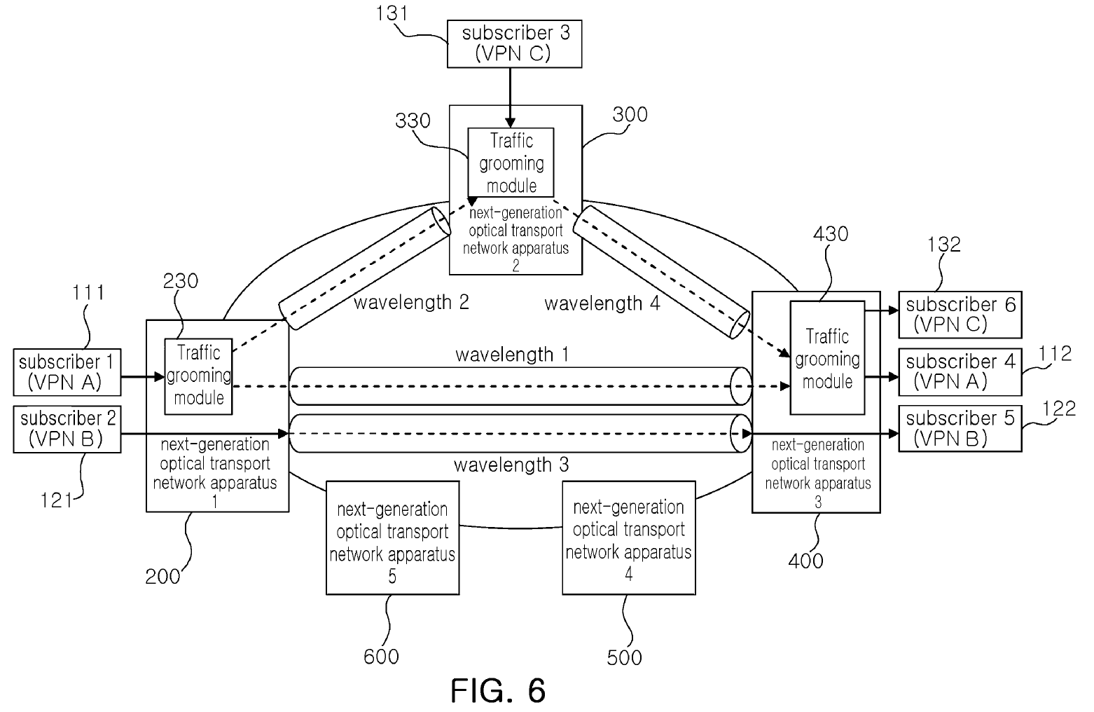

FIG. 6 illustrates traffic transmission between VPNs via an Ethernet-based next-generation optical transport network according to an exemplary embodiment of the present invention, in which the subscriber 1(111) and the subscriber 4(112) constituting the VPN A are connected through the wavelength 1 or through the wavelengths 2 and 4, the subscriber 2(121) and the subscriber 5(122) constituting the VPN B are connected through the wavelength 3, and the subscriber 3(131) and the subscriber 6(132) constituting the VPN C are connected through the wavelength 4.

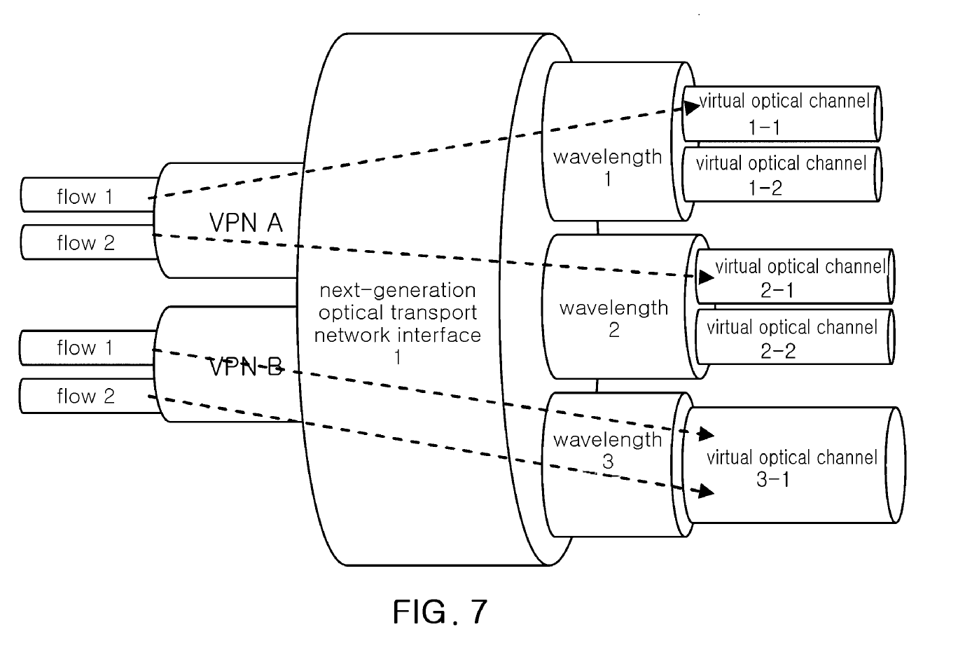

FIG. 7 illustrates a traffic grooming function in the next-generation optical transport network apparatus 1 in FIG. 6.

An Ethernet frame input from the VPN A in the next-generation optical transport network interface 1 is separated into two flows, i.e., flows 1 and 2, by the traffic grooming module (230 in FIG. 6), which are groomed to the virtual optical channels 1-1 and 2-1 and then mapped to the wavelengths 1 and 2. In this case, the flow 1, traffic having a higher priority level than the flow 2, is directly connected with the subscriber 4 (112 in FIG. 6) through the wavelength 1. Meanwhile the flow 2 having a lower priority level than the flow 1 is connected with the subscriber 4 (112 in FIG. 6) through the next-generation optical transport network 2 (300 in FIG. 6) through the wavelength 2.

Meanwhile, an Ethernet frame input from the VPN B in the next-generation optical transport network interface 1 is separated into two flows, i.e., the flows 1 and 2, by the traffic grooming module (230 in FIG. 6), which are all groomed to the virtual optical channel 3-1 and then mapped to the wavelength 3 so as to be directly connected to the subscriber 5 (122 in FIG. 6). In this case, the flows 1 and 2 have the same priority levels. In this case, the VPN B may be port-based connected, so, for traffic input from the VPN B, bandwidth may be port-based allocated and mapped to a pertinent wavelength without discriminating the flows.

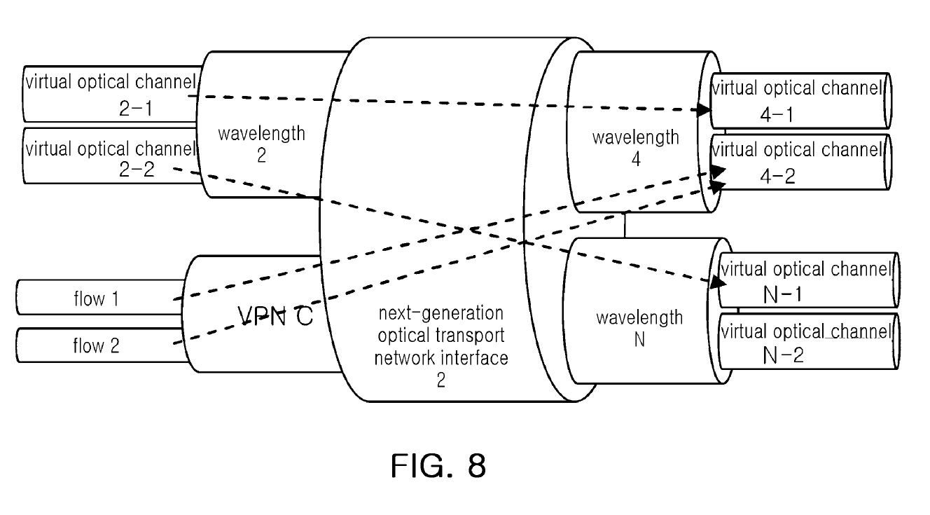

FIG. 8 illustrates a traffic grooming function in the next-generation optical transport network apparatus 2 in FIG. 6.

Traffic of virtual optical channel 2-1 input through the wavelength 2 in the next-generation optical transport network interface 2 is re-mapped to virtual optical channel 4-1 by the traffic grooming module (330 in FIG. 6) and then connected to the subscriber 4 (112 in FIG. 6) through the wavelength 4. Meanwhile, traffic of virtual optical channel 2-2 input through the wavelength 2 is re-mapped to virtual optical channel N−1 by the traffic grooming module (330 in FIG. 6) and then transmitted through the wavelength N. In this case, the wavelength N refers to a wavelength connected to a subscriber N not shown in FIG. 6.

An Ethernet frame input from the VPN C in the next-generation optical transport network interface 2 is separated into two flows, namely, into flows 1 and 2, which are all groomed to virtual optical channel 4-2 and then mapped to the wavelength 4 so as to be directly connected to the subscriber 6 (132 in FIG. 6). In this case, the flows 1 and 2 have the same priority levels. In this case, the VPN C may be port-based connected, so, for traffic input from the VPN C, bandwidth may be port-based allocated and mapped to a pertinent wavelength without discriminating the flows.

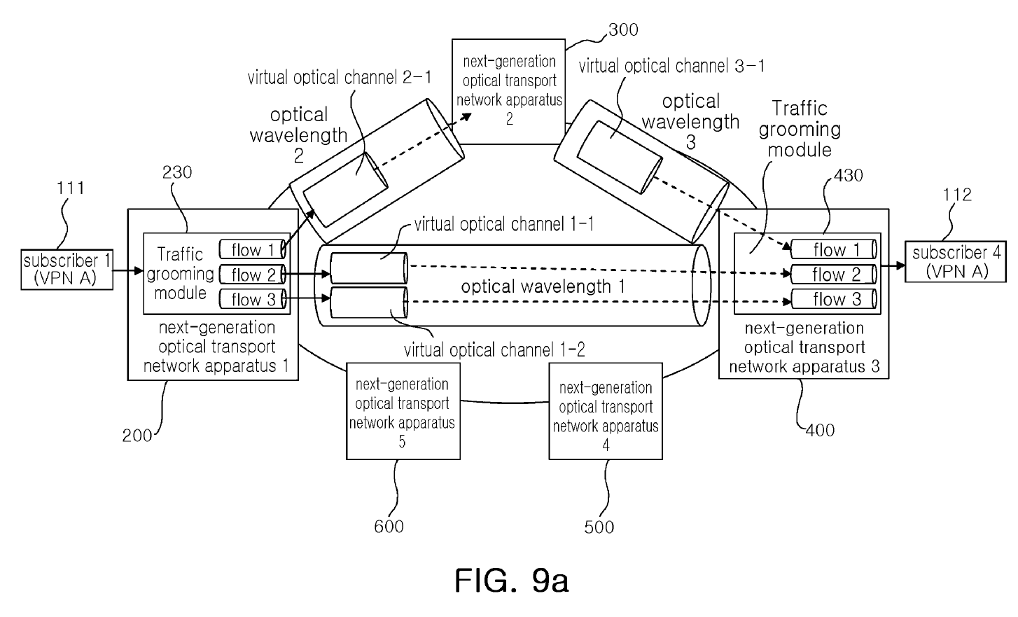

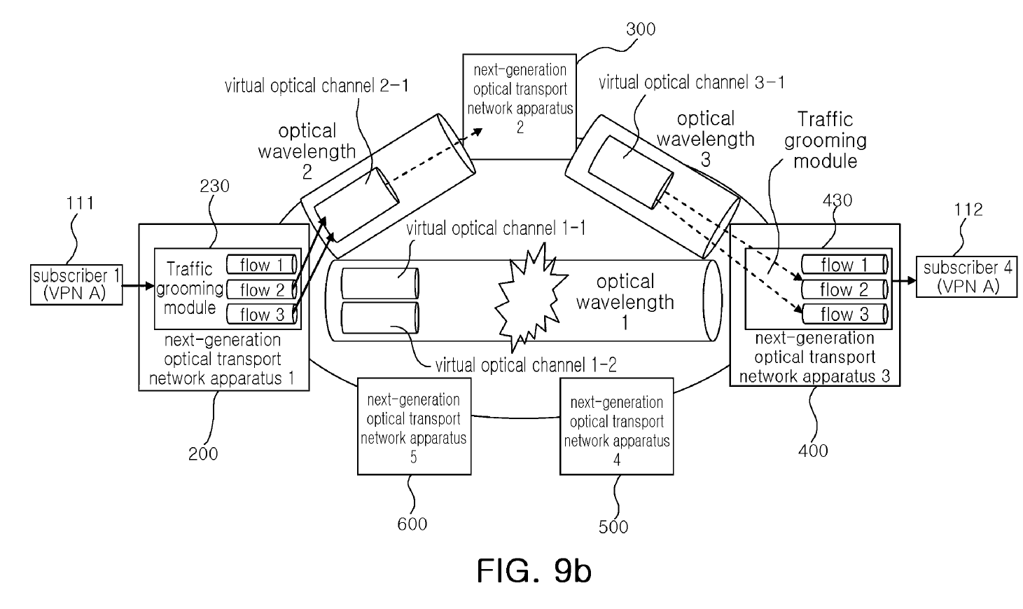

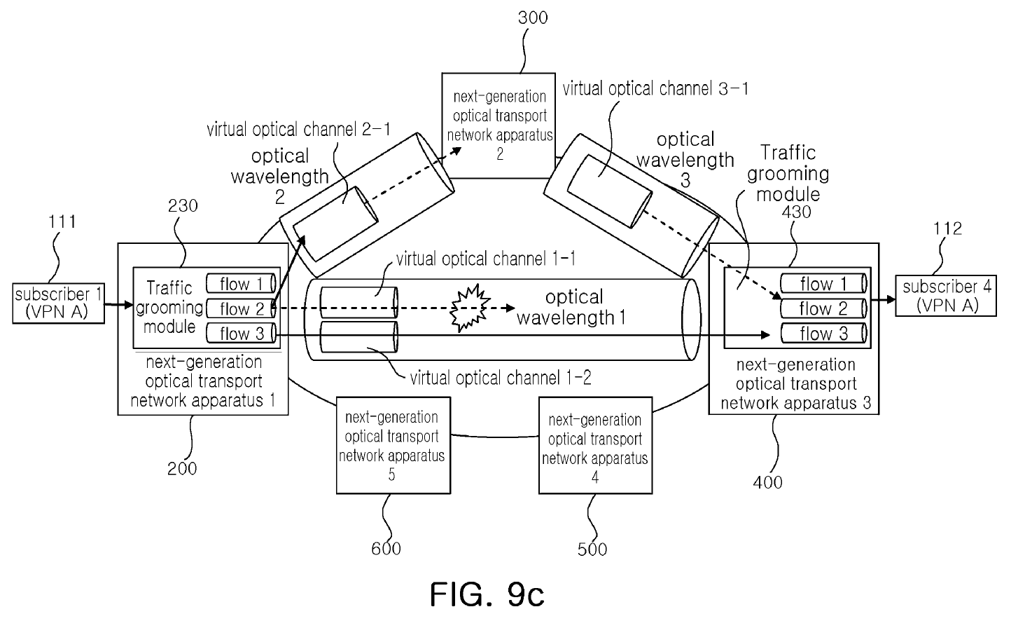

FIGS. 9a to 9c illustrate protection switching through virtual optical channels in the Ethernet-based next-generation optical transport network according to an exemplary embodiment of the present invention.

With reference to FIG. 9a, traffic input from the subscriber 1(111) constituting the VPN A is separated into flows 1 to 3 by the traffic grooming module 230. The flow 1, having the lowest priority level among the flows 1 to 3, is mapped to the virtual optical channel 2-1 and then transmitted through the optical wavelength 2. Meanwhile, the flows 2 and 3 having a higher priority level than the flow 1 are mapped to the virtual optical channels 1-1 and 1-2, respectively, which are then transmitted through the optical wavelength 1.

FIG. 9b illustrates protection switching when the optical wavelength 1 operating in the Ethernet-based next-generation optical transport network illustrated in FIG. 9a has an error. In this case, the flows 2 and 3 having a higher priority level than the flow 1 are re-mapped to the virtual optical channel 2-1. Accordingly, traffic of the flows 2 and 3 having the higher priority level is transmitted through the optical wavelengths 2 and 3, only making a loss of traffic of the flow 1 having the relatively low priority level.

FIG. 9c illustrates protection switching when the optical wavelength 1-1 operating in the Ethernet-based next-generation optical transport network illustrated in FIG. 9a has an error. In this case, the flow 2 having a higher priority level than the flow 1 is re-mapped to the virtual optical channel 2-1. Accordingly, traffic of the flow 2 having the higher priority level is transmitted through the optical wavelengths 2 and 3, only making a loss of traffic of the flow 1 having the relatively low priority level.

In this manner, in the Ethernet-based next-generation optical transport network, flows are generated in consideration of a priority level of data desired to be transmitted, and virtual optical channels are allocated to each flow, thus providing a protection switching function differentiated for each flow.

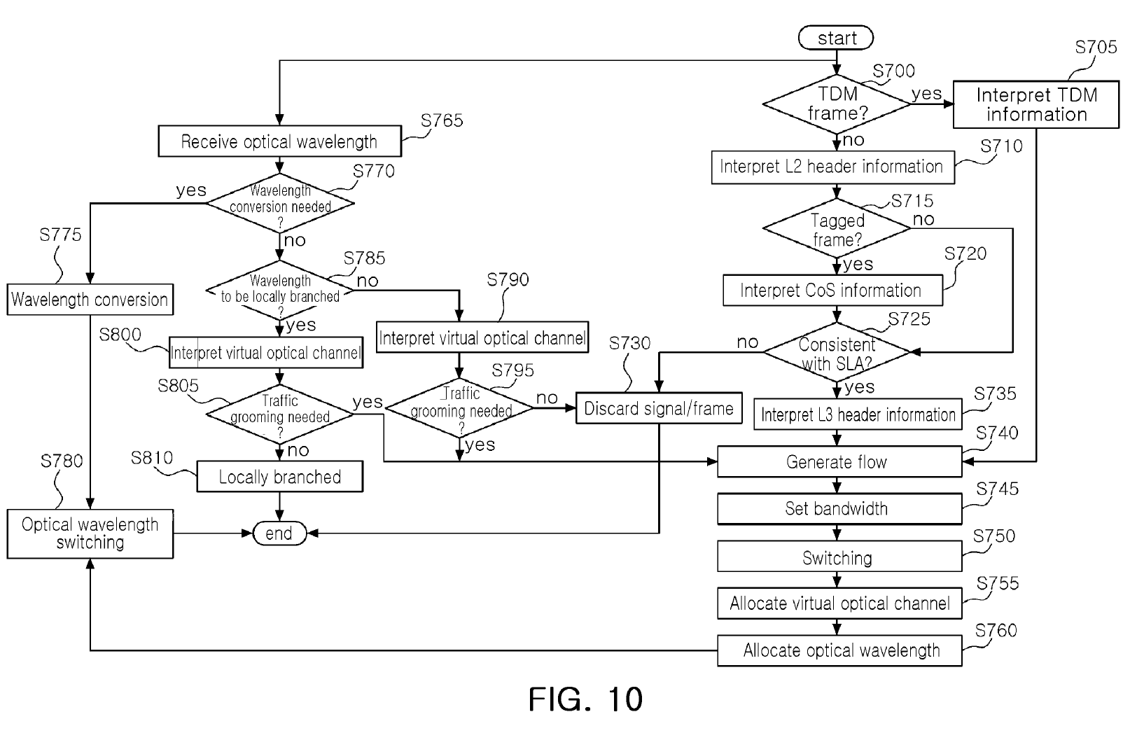

FIG. 10 is a flow chart illustrating the process of transmitting an Ethernet frame and a TDM frame via the Ethernet-based next generation optical transport network according to an exemplary embodiment of the present invention.

First, the subscriber network interface (540 in FIG. 2) receives various protocol signals from the subscriber network and classifies Ethernet signals and TDM signals (S700).

If a signal input from the subscriber network is a TDM frame, the TDM information processing unit (532 in FIG. 3) interprets the received TDM frame header information (S705) and generates a flow according to corresponding results (S740).

Meanwhile, if a signal input from the subscriber network is an Ethernet frame, the L2/L3+ information processing unit (531 in FIG. 3) interprets Le header information of the received Ethernet frame (S710). If the received Ethernet frame is a tagged frame (S715), the L2/L3+ information processing unit interprets the class of service (CoS) information to acquire the Ethernet frame priority level information (S720). Further, the L2/L3+ information processing unit determines whether or not the received Ethernet frame is consistent with the service level agreement (SLA) (S725). If the received Ethernet frame is not consistent with the SLA, the L2/L3+ information processing unit discards the corresponding Ethernet frame (S730), thus classifying only Ethernet frames suiting the SLA, according to the SLA. The L2/L3+ information processing unit then interprets a service type and a L3 header information of the classified Ethernet frames (S735).

Thereafter, the flow generation unit (533 in FIG. 5) generates flows from the Ethernet frame and the TDM frame which has undergone the information processing procedure performed by the L2/L3+ information processing unit (531 in FIG. 3) and the TDM information processing unit (532 in FIG. 3) as described above (S740). In this case, the flows are generated in consideration of the priority levels by destinations and the services of respective frames by using one or more of physical optical interface information of a subscriber, L2 header information, VLAN tag information, a service type, L3 header information, and header information of a TDM frame.

A bandwidth is set based on virtual optical channels (if necessary, a bandwidth may be set based on flows or ports) (S745), the generated flows are switched by the switching unit (534 in FIG. 3) (S750), and the virtual optical channel generation/termination unit (535 in FIG. 3) allocates virtual optical channels to the generated flows (S755).

Thereafter, the virtual optical channels, which have been allocated to the generated flows, are allocated a wavelength that can be operated in the network by the optical wavelength allocation unit (536 in FIG. 3) (S760), switched by the optical wavelength switching module (580 in FIG. 2) (S780), and then output to the corresponding network.

Meanwhile, when an optical wavelength is received via the optical demultiplexers (521 and 522 in FIG. 2) (S765), it is determined whether or not the received optical wavelength needs to be converted (S770). If the received optical wavelength needs to be converted, it is converted by the optical wavelength conversion module (560 in FIG. 2) (S775), switched by the switching module (580 in FIG. 2), and then output to the corresponding network.

Meanwhile, if the received optical wavelength does not need to be converted, it is determined whether or not the received optical signal is a channel signal to be branched to a local network (S785). If the received optical signal is a signal which is not used in a local network, a virtual optical channel is separated from the received optical wavelength and the virtual optical channel information is interpreted (S790). Thereafter, it is determined whether or not the virtual optical channel needs traffic grooming upon its interpretation (S795). If the virtual optical channel needs traffic grooming, the flow generation unit (533 in FIG. 3) generates a new flow (S740). The flow generated thusly through the above-mentioned process undergoes bandwidth setting (S745) and a switching (S750) process so as to be allocated a new virtual optical channel (S755), and at this time, traffic is groomed with another flow.

Meanwhile, if the virtual optical channel does not need traffic grooming, the corresponding optical signal is discarded (S730).

Meanwhile, if the received optical signal is a channel signal used in the local network, a virtual optical channel is separated from the received optical wavelength and the virtual optical channel information is interpreted (S800) to determine whether or not the virtual optical channel needs traffic grooming (S805). If the virtual optical channel needs traffic grooming, the flow generation unit (533 in FIG. 3) generates a new flow (S740). The flow generated newly through such process undergoes a bandwidth setting (S745) and switching (S750) process so as to be allocated a new virtual optical channel (S755), and at this time, traffic is groomed with another flow.

Meanwhile, if the virtual optical channel does not need traffic grooming, it is branched to a local node through the subscriber network interface (540 in FIG. 2) (S810).

As set forth above, according to exemplary embodiments of the invention, Ethernet data and a TDM signal can be transmitted through the same wavelength, and because a traffic grooming function is provided for each flow, network resources can be more effectively managed.

In addition, because every node requiring switching does not need to perform electro-optic and photoelectric conversion to switch the Ethernet data, so the Ethernet data can be effectively switched.

Moreover, when Ethernet data is transmitted through a plurality of optical wavelengths, Ethernet frames are classified by flows and optical paths are set for each flow, thereby guaranteeing quality of service (QoS) differentiated by Ethernet frames and providing a protection switching function.

While the present invention has been shown and described in connection with the exemplary embodiments, it will be apparent to those skilled in the art that modifications and variations can be made without departing from the spirit and scope of the invention as defined by the appended claims.

What is claimed is:

1. An Ethernet-based next generation optical transport network apparatus comprising:
a subscriber network interface configured to provide an interface with a subscriber network;
one or more optical signal distributors configured to branch a wavelength division multiplexed (WDM) optical signal input from an adjacent node;
one or more optical demultiplexers configured to demultiplex the WDM optical signals which have been input from the optical signal distributors, by wavelengths;
a traffic grooming module configured to classify Ethernet frames and TDM frames, which have been input from the subscriber network interface, by the flows and allocate virtual optical channels, and separate virtual optical channels from an optical wavelength which has been input from the optical demultiplexer and allocate new virtual optical channels;
an optical wavelength conversion module configured to allocate a new optical wavelength to a signal input from the traffic grooming module;
one or more optical multiplexers configured to perform wavelength division multiplexing (WDM) on a plurality of optical wavelength signals input from the traffic grooming module;
an optical wavelength switching module configured to switch optical wavelengths input from the optical signal distributor and the optical multiplexer; and
a control module configured to generate a control signal for controlling the traffic grooming module, the optical wavelength conversion module, and the optical wavelength switching module based on resources available in a network, and provide the generated control signal.

2. The apparatus of claim 1, wherein, if the optical wavelength input from the optical demultiplexer needs wavelength conversion, the traffic grooming module transfers the optical wavelength to the optical wavelength conversion module, while if the optical wavelength is used in a local network, the traffic grooming module transfers the optical wavelength to the subscriber network interface.

3. The apparatus of claim 1, wherein the traffic grooming module comprises:
an L2/L3+ information processing unit configured to process L2/L3 or higher information of the Ethernet frame which has been input via the subscriber network interface;
a TDM information processing unit configured to process TDM frame header information which has been input via the subscriber network interface;
a flow generation unit configured to generate a flow from the Ethernet frame which has been input from the L2/L3+ information processing unit and the TDM frame which has been input from the TDM information processing unit;
a switching unit configured to switch the flow which has been generated by the flow generating unit;
a virtual optical channel generation/termination unit configured to allocate a virtual optical channel to the flow which has been input from the switching unit; and
an optical wavelength allocation unit configured to allocate a pertinent wavelength to the virtual optical channel which has been input from the virtual optical channel generation/termination unit and map it to one or more optical wavelengths.

4. The apparatus of claim 3, wherein the virtual optical channel generation/termination unit separates the virtual optical channel from the optical wavelength which has been input via the optical demultiplexer and interpret and process virtual optical channel information.

5. The apparatus of claim 4, wherein the virtual optical channel generation/termination unit discriminates a virtual optical channel which needs traffic grooming or a virtual optical channel which needs local branching by interpreting the virtual optical channel information, allocates a new flow to the virtual optical channel which needs traffic grooming, and grooms it together with the frame which has been input via the subscriber network interface.

6. The apparatus of claim 3, wherein the L2/L3+ information processing unit interprets L2/L3 or higher input Ethernet frame header information, acquires input Ethernet frame priority information upon interpreting class of service (CoS) information, interprets an Ethernet frame service type classified according to a service level agreement (SLA), and discards the Ethernet frame if it is not consistent with the SLA.

7. The apparatus of claim 3, wherein the flow generation unit generates flows in consideration of priority levels of respective frames by destinations and services by using one or more of physical optical interface information of a subscriber, L2 header information, VLAN tag information, a service type, L3 header information, and header information of a TDM frame.

8. The apparatus of claim 1, wherein the traffic grooming module allocates a virtual optical channel to the flows which have been generated in consideration of the priority levels of the input Ethernet frames by the destinations and service.

9. The apparatus of claim 8, wherein, if a virtual optical channel, which has been allocated to a flow with a higher priority level among the generated flows, has an error, the traffic grooming module reallocates a virtual optical channel, which has been allocated to a flow with a lower priority level, to the flow with the higher priority level.

10. A traffic grooming method comprising:
processing L2/L3 or higher information of an input Ethernet frame;
processing header information of input TDM frame;
generating a flow from the Ethernet frame and the TDM frame;
switching the generated flow;
allocating a virtual optical channel based on the generated flow; and
mapping the virtual optical channel to an optical wavelength.

11. The method of claim 10, wherein processing of the L2/L3 or higher information comprises:
interpreting L2 header information of the input Ethernet frame;
if the input Ethernet frame is a tagged frame, acquiring priority information of the Ethernet frame by interpreting class of service (CoS) information;
classifying the input Ethernet frame according to a service level agreement (SLA); and
interpreting service type and L3 header information of the Ethernet frame which has been classified according to the SLA.

12. The method of claim 11, wherein processing of the L2/L3 or higher information further comprises:
if the input Ethernet frame is not consistent with the SLA, discarding the input Ethernet frame.

13. The method of claim 10, wherein generating of the flow, the flow is generated in consideration of priority levels of respective frames by destinations and services by using one or more of physical optical interface information of a subscriber, L2 header information, VLAN tag information, a service type, L3 header information, and header information of a TDM frame.

14. The method of claim 10, wherein the traffic grooming method further comprises:
determining whether or not a received optical wavelength needs to be converted;
if the received optical wavelength needs to be converted, converting the wavelength; and
switching the optical wavelength and outputting the same.

15. The method of claim 14, further comprising:
if the received optical wavelength does not need to be converted, determining whether or not the received optical wavelength is to be locally branched;
if the received optical wavelength is a signal used in a local network, separating a virtual optical channel from the optical wavelength and interpreting virtual optical channel information;
determining whether or not the separated virtual optical channel needs traffic grooming; and
if the separated virtual optical channel needs traffic grooming, generating a new flow including the separated virtual optical channel in the step of generating of the flow.

16. The method of claim 15, further comprising:
if the separated virtual optical channel does not need traffic grooming, branching the virtual optical channel into a local node.

17. The method of claim 14, further comprising:
if the received optical wavelength does not need to be converted, determining whether or not the received optical wavelength is to be locally branched;
if the received optical wavelength is a signal which is not used in the local network, separating a virtual optical channel from the optical wavelength and interpreting virtual optical channel information;
determining whether or not the separated virtual optical channel needs traffic grooming; and
if the separated virtual optical channel needs traffic grooming, generating a new flow including the separated virtual optical channel in the step of generating of the flow.

18. The method of claim 17, further comprising:
if the separated virtual optical channel does not need traffic grooming, discarding the virtual optical channel.
